(19) United States
(12) Patent Application Publication
(10) Pub. No.: US 2025/0267187 A1
(43) Pub. Date: Aug. 21, 2025

(54) ELECTRONIC DEVICE, METHOD, AND STORAGE MEDIUM FOR RADIO COMMUNICATION SYSTEM

(71) Applicant: Sony Group Corporation, Tokyo (JP)

(72) Inventors: Tao CUI, Beijing (CN); Chen SUN, Beijing (CN)

(73) Assignee: Sony Group Corporation, Tokyo (JP)

(21) Appl. No.: 18/857,465

(22) PCT Filed: Apr. 26, 2023
(86) PCT No.: PCT/CN2023/090868

§ 371 Date: Oct. 17, 2024

(30) Foreign Application Priority Data
Apr. 29, 2022 (CN) 202210471942.2

(51) Int. Cl. H04L 67/104; H04L 67/1042; H04W 4/029; H04W 4/08

(52) U.S. Cl. CPC H04L 67/1044; H04L 67/1042; H04W 4/029; H04W 4/08

(57) ABSTRACT

An electronic device on a network device side comprises a processing circuitry configured to: determine a first-level federated learning (FL) server entity and a plurality of corresponding FL participant entities, wherein one first-level FL server entity and its corresponding plurality of FL participant entities collectively form a group, and the first-level FL server entity can function as an FL participant of a second-level FL server entity comprised in the electronic device to perform federated learning with the second-level FL server entity; and transmit information of the formed group to the first-level FL server entity and the corresponding FL participant entities, to enable federated learning to be performed within each group. Due to the introduction of the first-level federated learning server entity and the group, a local-model can be quickly updated within the group, so that a terminal device can obtain a more accurate model in a shorter time.

### TECHNICAL FIELD

The present disclosure relates to the field of radio communication, and more specifically, to an electronic device, a method, and a storage medium for performing federated learning in the field of radio communication.

### BACKGROUND

Federated learning (FL) has become a very important distributed artificial intelligence framework or distributed machine learning framework at present, because it has unique advantages in ensuring data privacy security and legality and compliance, and can improve an effect of a machine learning model by collective modeling of a plurality of devices.

In traditional federated learning, an FL server (e.g., a cloud server) can generate one global-model by aggregating local-models obtained by local training of a plurality of terminal devices. Specifically, the FL server first initializes the local-models in the terminal devices, and in each iteration operation, each terminal device relies on its local training data to perform training learning on the local-model. Then, the terminal device may report the local-model (specifically, parameters of the local-model, which may be characterized, for example, in a manner of a gradient) to the FL server through an uplink of a radio communication system (e.g., a 5G network). The FL server aggregates the local-model parameters from the plurality of terminal devices (e.g., averages the local-model parameters of the terminal devices) to obtain an updated global-model. Then, the updated global-model (specifically, parameters of the global-model) may be distributed to each terminal device through a downlink of the radio communication system. Therefore, each terminal device updates the local-model according to the received global-model, and then proceeds to perform a next round of local training based on the updated local-model.

Combination of federated learning and a radio communication network is gradually becoming one of trends in future network intellectualization. For a radio communication system, federated learning needs to be adjusted to adapt to a time-varying radio channel environment, unstable training data, and device heterogeneity. At present, in a procedure of enabling federated learning in a radio communication system, a base station serves as a server for federated learning, and terminal devices serve as participants for federated learning, so that the base station can, by aggregating local-models from the terminal devices, obtain a global-model, and transmit the global-model to the terminal devices to update the local-models thereof.

However, the existing federated learning only involves a two-layer architecture, one layer being the server that distributes the global-model and aggregates the uploaded local-models, and the other layer being the terminal devices that serve as the federated learning participants. Such a two-layer architecture requires each FL participant to directly communicate with the FL server; considering time-varying characteristics and instability of radio channels, latency of communication between the server and the participants may be great, so that it takes a long time to obtain the global-model by aggregating the local-models, and thus the participants cannot quickly obtain a more accurate model, and accordingly, prediction processing according to the local-models may be affected.

Therefore, it is desired that a novel federated learning architecture can be provided, so that the terminal devices can, in a shorter time, obtain a more accurate model than a local-model obtained based on only local data.

### SUMMARY

One aspect of the present disclosure relates to an electronic device used on a network device side in a radio communication system. According to one embodiment, the electronic device may comprise a processing circuitry, which may be configured to: determine at least one first-level federated learning (FL) server entity and a plurality of FL participant entities corresponding to each first-level FL server entity, wherein one first-level FL server entity and its corresponding plurality of FL participant entities collectively form a group, and the at least one first-level FL server entity can function as an FL participant of a second-level FL server entity comprised in the electronic device to perform federated learning with the second-level FL server entity; and transmit information of the formed group to the at least one first-level FL server entity and the FL participant entities corresponding to each first-level FL server entity, to enable federated learning to be performed within each group.

Another aspect of the present disclosure relates to an electronic device used on a user equipment side in a radio communication system. According to one embodiment, the electronic device may comprise a processing circuitry, which may be configured to: receive, from an electronic device on a network device side, information of a group where the electronic device on the user equipment side is, wherein the group comprises one first-level FL server entity and its corresponding plurality of FL participant entities, and at least one first-level FL server entity determined by the electronic device on the network device side can function as an FL participant of a second-level FL server entity comprised in the electronic device on the network device side to perform federated learning with the second-level FL server entity; and perform federated learning within the group based on the information of the group.

Yet another aspect of the present disclosure relates to a method used in a radio communication system. According to one embodiment, the method may comprise: determining at least one first-level federated learning (FL) server entity and a plurality of FL participant entities corresponding to each first-level FL server entity, wherein one first-level FL server entity and its corresponding plurality of FL participant entities collectively form a group, and the at least one first-level FL server entity can function as an FL participant of a second-level FL server entity comprised in a network device to perform federated learning with the second-level FL server entity; and transmitting information of the formed group to the at least one first-level FL server entity and the FL participant entities corresponding to each first-level FL server entity, to enable federated learning to be performed within each group.

Yet another aspect of the present disclosure relates to a method used in a radio communication system. In one embodiment, the method may comprise: receiving, from a network device, information of a group where a terminal device is, wherein the group comprises one first-level FL server entity and its corresponding plurality of FL participant entities, and at least one first-level FL server entity determined by the network device can function as an FL participant of a second-level FL server entity comprised in the network device to perform federated learning with the second-level FL server entity; and performing federated learning within the group based on the information of the group.

Yet another aspect of the present disclosure relates to a computer-readable storage medium having one or more instructions stored thereon. In some embodiments, the one or more instructions may, when executed by one or more processors of an electronic device, cause the electronic device to perform the above methods.

The above summary is provided to summarize some exemplary embodiments to provide a basic understanding of aspects of the subject matter described herein. Thus, the above features are merely examples and should not be construed to narrow the scope or spirit of the subject matter described herein in any way. Other features, aspects, and advantages of the subject matter described herein will become apparent from the following detailed description that is described in conjunction with the accompanying drawings.

### BRIEF DESCRIPTION OF THE DRAWINGS

A better understanding of this disclosure may be obtained when the following specific description of the embodiments is considered in conjunction with the accompanying drawings. The same or similar reference numbers are used in the drawings to indicate the same or similar components. The accompanying drawings together with the following specific description, which are incorporated in and form a part of this specification, are used for illustrating the embodiments of the present disclosure and explaining the principles and advantages of the present disclosure. In the drawings:

FIG. 1 is a schematic diagram of a procedure of federated learning in a radio communication network in the related art;

FIG. 2 is a schematic diagram of a federated learning architecture according to an embodiment of the present disclosure;

FIG. 3 is a flow diagram of a method performed by a network device in the federated learning architecture provided herein according to an embodiment of the present disclosure;

FIG. 4 is a flow diagram of a method performed by a terminal device in the federated learning architecture provided herein according to an embodiment of the present disclosure;

FIG. 5 is a flow diagram of a method used in a procedure of federated learning in the federated learning architecture provided herein according to an embodiment of the present disclosure;

FIG. 6 is a sequence diagram of an example of information exchange in the federated learning architecture provided herein according to an embodiment of the present disclosure;

FIG. 7 is a block diagram of an example structure of a personal computer as an information processing device employable in an embodiment of the present disclosure;

FIG. 8 is a block diagram illustrating a first example of a schematic configuration of a gNB to which the technique of the present disclosure can be applied;

FIG. 9 is a block diagram illustrating a second example of a schematic configuration of a gNB to which the technique of the present disclosure can be applied;

FIG. 10 is a block diagram illustrating an example of a schematic configuration of a smartphone to which the technique of the present disclosure can be applied; and

FIG. 11 is a block diagram illustrating an example of a schematic configuration of a car navigation device to which the technique of the present disclosure can be applied.

While the embodiments described in this disclosure may be prone to various modifications and alternative forms, specific embodiments thereof are illustrated as examples in the drawings and are described in detail herein. It should be understood, however, that the drawings and the detailed description thereof are not intended to limit the embodiments to the specific forms disclosed, but to cover all modifications, equivalents and alternative solutions falling within the spirit and scope of the claims.

### DETAILED DESCRIPTION

Representative applications in various aspects such as the device and method according to the present disclosure are described below. The description of these examples is merely to add context and help to understand the described embodiments. Therefore, it is apparent to those skilled in the art that the embodiments described below may be implemented without some or all of the specific details. In other cases, well-known procedure steps have not been described in detail to avoid unnecessarily obscuring the described embodiments. Other applications are also possible, and the solutions of the present disclosure are not limited to these examples.

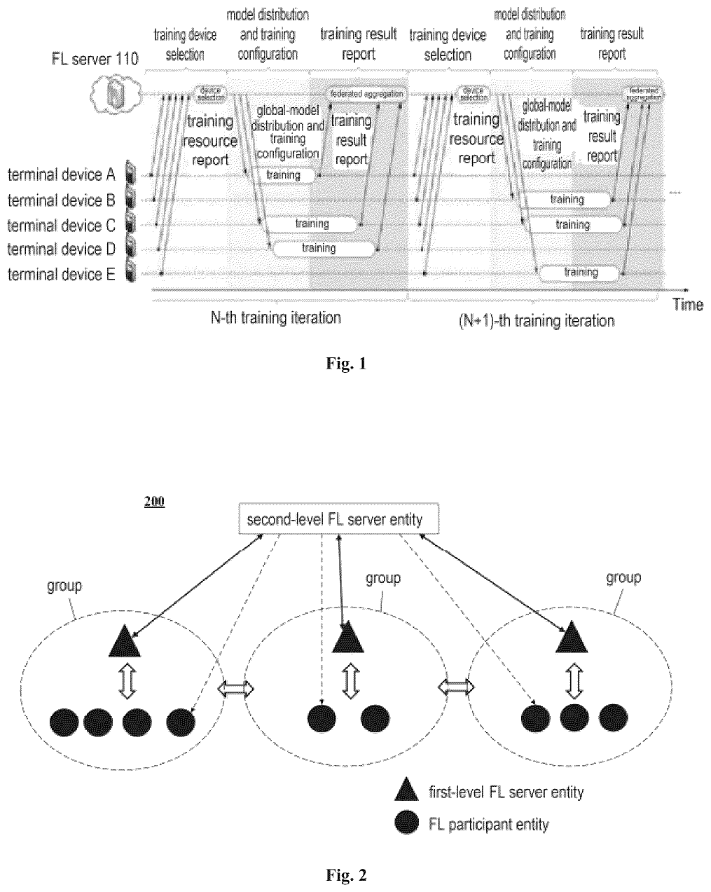

First, reference is made to FIG. 1 to describe how to implement federated learning in a radio communication network in the related art.

As shown in FIG. 1, an FL server (which may also be referred to as an FL training server, a cloud server, etc.) 110 and a plurality of terminal devices A to E collectively perform federated learning, to obtain a global-model by aggregating, by the FL server 110, local-models trained on local data by the terminal devices A to E, and update the local-models in the terminal devices by transmitting the global-model. The FL server 110 may be provided in a base station or in another network device. When the FL server 110 is provided in a base station, the terminal devices A to E are terminal devices which can communicate with it wirelessly, including any form of user equipment such as smartphones and desktop computers.

In each iteration of federated learning, the terminal devices A to E transmit, to the FL server 110, training resource reports, which include their respective available computing resources, radio channel environments, geographic locations, etc. The FL server 110 performs device selection among the terminal devices A to E according to the received reports, to determine terminal devices participating in model training in the current iteration. Since in addition to performing the federated learning task, the terminal devices A to E in the radio communication system may need to transmit other data services in an uplink, when these data services have a higher priority and low tolerance to latency, the transmission of these data may affect a capability of the terminal device to upload the local training model, so that the terminal device is not very suitable to participate in federated learning at this time, resulting in that the FL server will not select the terminal device according to the reports of the terminal devices. Therefore, a balance between the uploading of the local-model of the terminal device and the uploading of the service data of the terminal device needs to be considered in a procedure of terminal device selection.

In the example shown in FIG. 1, the FL server 110 selects, in an N-th iteration, the terminal devices A, C and D to perform federated learning. Next, the FL server 110 distributes the global-model and a training parameter configuration to the selected terminal devices A, C and D. Then, the terminal devices A, C and D update the local-models to be consistent with the global-model, and train the local-models based on the local data. Next, the terminal devices A, C and D report training results (e.g., parameters of the local-models) to the FL server 110. The FL server 110 performs aggregation according to the received training results to obtain a new global-model. So far, the N-th iteration procedure ends. In an (N+1)-th iteration, a procedure similar to the N-th iteration is performed. For example, in the example shown in FIG. 1, the FL server 110 selects the terminal devices B, C and E to perform federated learning according to re-reported training resource reports.

Although in the example of FIG. 1, it is needed to select terminal devices participating in federated learning at the beginning of each iteration, if conditions of the terminal devices (e.g., computing resources, radio channel environments, and the like of the terminal devices) do not change substantially, the operation of selecting the terminal devices and the operation of transmitting the training parameter configuration by the FL server are not needed upon each iteration. In addition, if one terminal device skips model aggregation iteration for federated learning one or more times, model accuracy for federated learning may be affected, and therefore the terminal devices participating in federated learning can be alternately arranged over time, so that sampling effects with independent and identical distribution can be ensured as much as possible to give equal opportunities for all the terminal devices to contribute to the global-model.

Since only a two-layer architecture is involved in federated learning in the related art, direct communication between the base station and the terminal device via a time-varying radio channel is required in each model update procedure, and thus there may be a certain room for improvement in the update speed of the local-model; and since the terminal devices selected each time to participate in federated learning may be different and incomplete, there is a case where not all of the local-models obtained by the terminal devices based on the local data are considered for the global-model, and therefore, there is also a certain room for improvement in the accuracy of the model. A novel federated learning architecture provided in an embodiment of the present disclosure will be described in detail hereinafter.

In FIG. 2, a schematic diagram of a federated learning architecture 200 according to an embodiment of the present disclosure is shown. The architecture is divided into three layers, wherein a first layer as a lower layer includes an FL participant entity, a second layer as an intermediate layer (which may also be considered as a layer performing preliminary aggregation) includes a first-level FL server entity, and a third layer as an upper layer (which may also be considered as a layer performing fine aggregation) includes a second-level FL server entity. It should be understood that the “entity” herein may be a hardware circuit or circuitry physically present in a tangible device such as a base station, user equipment, terminal device, and server device, or the tangible device itself (i.e., implemented in a hardware form), or may be computer-executable instructions or program code stored in a memory of a device capable of performing radio or network communication and executed on a processor of the device (i.e., implemented in a software form). In other words, the “entity” may be a physical entity or a logical entity. When an “entity comprised in a certain device” is mentioned, it may mean that the entity is a hardware component of the device or the device itself, or that the entity is computer-executable instructions or program code run in the device. Specifically, one FL participant entity may correspond to or be included in one terminal device, a first-level FL server entity may correspond to or be included in one terminal device, and a second-level FL server entity may correspond to or be included in one network-side device (e.g., a base station, a cloud server, or a control device in a core network). When an entity is located in a certain layer, its corresponding device will also be located in that layer. For one terminal device, it may include one FL participant entity only, or one first-level FL server entity only, or both of one FL participant entity and one first-level FL server entity. Although the network-side device may be a base station, a server device, or a control device in a core network, for simplicity of description, the description will be made hereinafter by taking an example that a base station is located in the third layer, and it can be understood by those skilled in the art that when the network-side device is another kind of device, the base station may be replaced with this device to implement the solution of the embodiment of the present disclosure.

In the architecture of FIG. 2, one first-level FL server entity and its corresponding plurality of FL participant entities form one group in which federated learning can be performed. At this time, the first-level FL server entity functioning as a server for the traditional federated learning and the FL participant entities functioning as participants for the traditional federated learning collectively perform federated learning. FIG. 2 shows three groups, each of which includes one first-level FL server entity indicated by a triangle in the figure and a plurality of FL participant entities indicated by circles in the figure. Here, the number of three groups and the number of the FL participant entities in the group are given only as examples, and those skilled in the art can understand that there can be more or fewer groups within a coverage area of the base station, and there can be more or fewer FL participant entities in each group. Although all the terminal devices are grouped in FIG. 2, there may be a case where a terminal device is not grouped. In this case, the ungrouped terminal device includes a first-level FL server entity, located in the second layer of the architecture. The first-level FL server entity in the second layer and the second-level FL server entity in the third layer may also perform federated learning. At this time, the second-level FL server entity functioning as a server for the traditional federated learning and the first-level FL server entity functioning as a participant for the traditional federated learning collectively perform federated learning.

Therefore, the first layer and the second layer can collectively perform federated learning, and the second layer and the third layer can collectively perform federated learning, so that the architecture of federated learning can be expanded to a plurality of layers. In this way, the terminal devices located in the first layer do not need to interact with the base station located in the third layer each time to update local-models, and they can quickly update the local-models by communicating with the terminal device located in the second layer, so that latency of the model update is improved. In addition, the base station located in the third layer can, from the second-layer terminal device which collects local-model related information of the first-layer terminal devices, receive more comprehensive model related information, so that the model related information which can be aggregated by the global-model is more comprehensive, and therefore the global-model can be more accurate.

To form the architecture shown in FIG. 2, the device located in the third layer (e.g., the base station) is required to group the terminal devices. Specifically, the base station receives, from terminal devices within its coverage area, one or more of processing capability, machine learning capability, geographic location, radio channel quality, and movement trajectory information of the terminal devices, which may be received, for example, through a Uu link. Although the link for receiving the above items is referred to as the Uu link here, it can be understood by those skilled in the art that the link may have another representation in a different standard, to describe communication between the base station and the terminal device using such a link. In a different embodiment, the base station may receive only a part of these items. For example, in a different embodiment, the base station may receive only the processing capability of the terminal devices, only the machine learning capability of the terminal devices, only the geographic location of the terminal devices, only the radio channel quality of the terminal devices, only the movement trajectory information of the terminal devices, or different combinations of these items.

Then, the base station may select a manager device from among the terminal devices within its coverage area according to the received items, each manager device comprising one first-level FL server entity. For example, the base station may determine, as manager devices, terminal devices with CPU processing speeds ranked top predetermined digit (for example, top one, top two, top three, etc.) in all the terminal devices, according to the CPU processing speeds reported by the terminal devices. The base station may also determine, as manager devices, terminal devices with more computing resources (for example, ranked top predetermined digit) allocated to machine learning, according to the computing resources for machine learning reported by the terminal devices. The base station may also determine distances between the terminal devices according to a distance from the base station or another terminal device reported by the terminal devices, and determine, as a manager device, at least one terminal device having a maximum number of adjacent terminal devices with a distance from the base station that is less than a predetermined value. The base station may also determine, as a manager device, at least one terminal device with good channel quality (e.g., a signal-to-noise ratio (SNR) is less than a predetermined value, a reference signal received power (RSRP) is greater than a predetermined value, etc.) or terminal devices with channel quality ranked top predetermined digit (e.g., top one, top two, top three, etc.) in all the terminal devices, according to a channel quality report reported by the terminal devices. In addition, the base station may also select, as a manager device, a terminal device which is expected to pass through a specific place, according to future path planning information reported by the terminal devices. It can be understood by those skilled in the art that the above examples may be flexibly combined, and there may be other manners of selecting a manager device by using the reported information.

After selecting the manager device, the base station may determine that terminal devices within a predetermined distance from the manager device are in the first layer and include FL participant entities, and collectively forms one group with the manager device. In different embodiments of the present disclosure, one terminal device may be located in only one group, or one terminal device may be located in two or more groups, for example, distances between the terminal device and different manager devices are all within a predetermined distance.

It has been mentioned above that the manager device may include both the first-level FL server entity and the FL participant entity, which means that the manager device actually may be a computationally powerful terminal device, not only performing training of the local-models, but also aggregating the local-models within the group as a manager of the group. At this time, the group where the manager device is includes the FL participant entity included in itself.

If there are ungrouped terminal devices, e.g., distances of these terminal devices from each manager device all exceed a predetermined distance, then these terminal devices are determined to include the first-level FL server entity, and will function as FL participants of the second-level FL server entity together with other first-level FL server entities also located in the second layer to perform federated learning.

After each group is determined, the base station may transmit information of the group to the terminal devices within its coverage area. For example, in different embodiments, the base station may transmit, to each terminal device in one group, one or more of an identifier ID of a terminal device where a first-level FL server entity in the group is and a group ID of the group. This means that the base station can transmit, to each terminal device in the group, only an identifier ID of a terminal device located in the second layer, only the group ID of the group, or both. The group ID of the group may be an ID assigned by the base station, or may be related to an identifier ID of the manager device, so that the terminal device can determine the manager device of the group where it is by analyzing these IDs. In addition, the base station may also transmit, to each terminal device in the group, a group ID of a group in an adjacent geographic location. For example, the base station may determine one or more other manager devices closest to the manager device in the group, and determine groups where these manager devices are as adjacent groups, and then may also notify group IDs of the adjacent groups to the terminal devices in the group, thereby facilitating communication with the adjacent groups.

Next, federated learning occurring between the first and second layers shown in FIG. 2, that is, federated learning within a group, will be described.

In a procedure of performing federated learning within a group, FL participant entities of the group upload local-model related information to a first-level FL server entity of the group, so that the first-level FL server entity updates local-models of the FL participant entities of the group by aggregating the received local-model related information. For example, the FL participant entities may upload the local-model related information to the first-level FL server entity using direct communication through links between the terminal devices where the FL participant entities are and the electronic device where the first-level FL server entity is. The local-model related information may be information related to parameters of the local-model (e.g., it may be an encrypted version of the parameters of the local-model), from which the first-level FL server entity can obtain the parameters of the local-model.

In another embodiment of the present invention, the updating of the local-model may be performed by transmitting an output result (which may also be referred to as a prediction result, a prediction score, etc.) of the local-model. At this time, the local-model related information may be an output result calculated by the FL participant entity according to common data transmitted by the first-level FL server entity based on the local-model. Specifically, the first-level FL server entity may first select a series of common data (e.g., a subset of a public data set) that functions as inputs of the local-models of the FL participant entities, and then transmit these common data to all the FL participant entities within the group where it is. The FL participant entities receiving the common data, by taking the common data as the inputs of the local-models, sequentially input the common data into the local-models trained by local data, to obtain a series of output results, and return these output results to the first-level FL server entity. After the first-level FL server entity receives the output result transmitted from each participant entity within the group, the first-level FL server entity may, by averaging these output results, determine an aggregated output result corresponding to the common data. The first-level FL server entity can transmit the obtained aggregated output result to each FL participant entity within the group, so that each FL participant entity can retrain the local-model to update the parameters of the local-model based on the previously received common data and the aggregated output result corresponding to the common data, thereby obtaining the updated local-model. Since the data used for retraining the local-model include information from other FL participant entities, the result is more accurate than the case where the FL participant entity performs training by using only the local data.

In addition to simple arithmetic average, the first-level FL server entity may obtain the aggregated output result by means of weighted average. For example, the first-level FL server entity may receive, from each FL participant entity within the group, some related information of a terminal device where the FL participant entity is, including two or more of a first quantity related to local-model prediction accuracy of the terminal device, a second quantity related to channel quality of the terminal device, and a third quantity related to historical and/or future trajectory of the terminal device, that is, at least two of these items may be received in different embodiments. The terminal device including the FL participant entity may calculate the first quantity to characterize the local-model prediction accuracy determined by comparing the local-model with the updated new local-model, and may also calculate the second quantity to characterize the channel quality based on CSI, SNR, RSRP, a bit error rate of a received signal, etc., and for example, the second quantity may be equal to CSI divided by RSRP of the received signal. Furthermore, the terminal device may also calculate the third quantity to reflect the historical and/or future trajectory, and for example, the third quantity may be greater if a distance the terminal device moves within a predetermined time period is longer. A weight corresponding to the FL participant entity comprised in the terminal device may be determined according to at least two of the first quantity, the second quantity and the third quantity by using the following formula:

$$weight = alpha * first quantity + beta * second quantity + gamma * third quantity$$

where alpha, beta, and gamma are predetermined constants that may be determined according to the importance of the first quantity, the second quantity and the third quantity, for example, when the first quantity is more important, a weight assigned to it may be greater. When the FL participant entity does not transmit any one of the first quantity, the second quantity and the third quantity to the first-level FL server entity, the corresponding term is omitted from the above weight formula accordingly. After calculating the weight corresponding to each FL participant entity, the first-level FL server entity may multiply the output result received from each FL participant entity by the corresponding weight and add the multiplying results, so that weighted summation is performed on the output results from the FL participant entities in a weighted manner to obtain the aggregated output result.

In an embodiment of the present disclosure, the above weight may also be received from the base station, in addition to being determined by the first-level FL server entity according to the information reported by the FL participant entities. In this case, the base station is required to calculate weights corresponding to the FL participant entities. For example, the FL participant entity may directly transmit the above first, second and/or third quantity(s) to the base station (e.g., the second-level FL server entity included in the base station), and the base station calculates a weight of each FL participant entity in the same manner that the first-level FL server entity calculates the weight, and transmits the calculated weight to the first-level FL server entity of the group where the FL participant entity is. The first-level FL server entity receiving the weights may weight the output results uploaded by the corresponding FL participant entities by using the received weights as described above, to obtain the aggregated output result.

By means of weighted summation, the aggregated output result can be made more consistent with the actual situation of each FL participant entity and therefore more accurate. Furthermore, the transmission of the output result and the aggregated output result is safer due to reduced exposure to an internal state of the model, and the amount of data transmitted and the communication load are also significantly reduced, compared to the traditional manner of transmitting model parameters among parties of federated learning.

In addition, the output result calculated by the FL participant entity according to the common data transmitted by the first-level FL server entity may be transmitted to other FL participant entities located in the same group in a unicast or multicast manner. For example, the FL participant entity may transmit a request message to the other FL participant entities through synchronization channel information (SCI), and then transmit the output result to the other FL participant entities by carrying, by the SCI, information for demodulating and decoding a physical side link control channel (PSSCH) and by carrying the output result by the PSSCH. The operation of transmitting the SCI may be completed in the stage-1 (stage 1), and the operation of transmitting the SCI and the PSSSCH may be completed in the stage-2 (stage 2).

In a case where a different group has the same common data, the FL participant entity may also transmit the output result to an FL participant entity of the different group in a unicast or multicast manner, wherein such transmission may be performed through a PC5 link. Therefore, the information related to the local-model of the FL participant entity can be shared more quickly, facilitating other FL participant entities to learn new knowledge. On the other hand, the operation of uploading the output result to the first-level FL server entity by the FL participant entity may be performed in a manner of D2D. In a case where a different group has the same common data, the FL participant entity may also upload the output result to a first-level FL server entity of the different group in the manner of D2D to more quickly share the model related information.

For a first-level FL server entity, since it functions as the FL server of FL participant entities to collectively perform federated learning, the first-level FL server entity has a global-model valid within the group, which is an aggregation result of the local-models of the FL participant entities of the group where the first-level FL server entity is, and may also be referred to as a local global-model. The first-level FL server entity can also train the local global-model according to the above common data and the aggregated output result, thereby obtaining parameters of the local global-model. Instead of the aggregated output result transmitted to the FL participant entities as described above, the parameters of the local global-model may be transmitted to the FL participant entities to update their local-models. In other words, when the FL participant entity uploads, to the first-level FL server entity, the output result obtained by the local-model based on the common data, in different embodiments of the present disclosure, the first-level FL server entity may transmit the aggregated output result to the FL participant entity, or transmit the parameters of the local global-model to the FL participant entity, to update the local-model of the FL participant entity.

It is noted that since there may be an ungrouped terminal device, which is located in the second layer as described above, and there are no other terminal devices located under this terminal device, a local global-model of a first-level FL server entity included in this terminal device is not obtained by aggregating the local-models of the FL participant entities, but obtained by interaction with the second-level FL server entity located in the third layer and local training. For example, the second-level FL server entity may transmit the global-model to the ungrouped terminal device to initialize the local global-model therein, and the ungrouped terminal device may train the local global-model based on local data to update the local global-model for uploading to the second-level FL server entity.

When a first-level FL server entity receives a request from an FL participant entity of another group, the first-level FL server entity may transmit the parameters of the local global-model to the FL participant entity, so that it quickly updates its local-model. For example, when an FL participant entity is moving from one group to another, in order to obtain model related information of the new group more quickly, the FL participant entity may request, according to a group ID of an adjacent group transmitted by the base station, a first-level FL server entity of the adjacent group to transmit a local global-model.

Next, federated learning occurring between the second and third layers shown in FIG. 2 will be described.

In a procedure of federated learning between the second and third layers, the second-level FL server entity included in the base station receives local global-model related information from first-level FL server entities included in terminal devices, and updates local global-models of the first-level FL server entities by aggregating the received local global-model related information. For example, the local global-model related information may be information related to parameters of the local global-model (e.g., it may be an encrypted version of the parameters of the local global-model), from which the second-level FL server entity can obtain the parameters of the local global-model.

In another embodiment of the present invention, the updating of the local global-model may be made by transmitting an output result of the local global-model. At this time, the local global-model related information may be an output result calculated by the first-level FL server entity according to common data transmitted by the second-level FL server entity based on the local global-model. Specifically, the second-level FL server entity may first select a series of common data (e.g., a subset of a public data set) that functions as inputs of the local global-models of the first-level FL server entities, and then transmit these common data to the first-level FL server entities within a coverage area of the second-level FL server entity. The first-level FL server entities receiving the common data, by taking the common data as the inputs of the local global-models, sequentially input the common data into the local global-models, thereby obtaining a series of output results, and return these output results to the second-level FL server entity. After the second-level FL server entity receives these output results, the second-level FL server entity can determine an aggregated output result corresponding to the common data by averaging these output results. The second-level FL server entity can transmit the obtained aggregated output result to each first-level FL server entity, so that each first-level FL server entity can retrain the local global-model to update the parameters of the local global-model based on the previously received common data and the corresponding aggregated output result, thereby obtaining the updated local global-model. Since the local global-model is retrained by using the data including information from other first-level FL server entities (and thereby information of other FL participant entities), it may be more accurate than a local global-model obtained by the first-level FL participant entity using only the local-models within the group.

in addition to simple arithmetic average, the second-level FL server entity can obtain the aggregated output result by means of weighted average. For example, the second-level FL server entity may receive, from each first-level FL server entity, some related information of a terminal device where the first-level FL server entity is, including two or more of a first quantity related to local global-model prediction accuracy of the terminal device, a second quantity related to channel quality of the terminal device, and a third quantity related to historical and/or future trajectory of the terminal device, i.e., at least two of these items may be received in different embodiments. The terminal device including the first-level FL server entity may calculate the first quantity to characterize the local global-model prediction accuracy determined by comparing the local global-model with the new local global-model updated based on the data transmitted by the second-level FL server entity, and may also calculate the second quantity to characterize the channel quality based on CSI, SNR, RSRP, a bit error rate of a received signal, etc., and for example, the second quantity may be equal to CSI divided by RSRP of the received signal. In addition, the terminal device including the first-level FL server entity may also calculate the third quantity to reflect the historical and/or future trajectory, and for example, the third quantity may be greater if a distance the terminal device moves within a predetermined time period is longer. A weight corresponding to the first-level FL participant entity comprised in the terminal device may be determined according to at least two of the first quantity, the second quantity and the third quantity by using the following formula:

$$weight = {alpha}^{′} * first quantity + {beta}^{′} * second quantity + {gamma}^{′} * third quantity$$

where alpha′, beta′, and gamma′ are predetermined constants, which may be the same as or different from the above alpha, beta, and gamma, and may be determined according to the importance of the first quantity, the second quantity, and the third quantity, and for example, when the first quantity is more important, a weight assigned to it may be greater. When the first-level FL server entity does not transmit any of the first quantity, the second quantity, and the third quantity to the second-level FL server entity, the corresponding item is omitted from the above weight formula accordingly. After calculating the weight corresponding to each first-level FL server entity, the second-level FL server entity may multiply the output result received from each first-level FL server entity by the corresponding weight and add the multiplying results, so that weighted summation is performed on the output results from the first-level FL server entities in a weighted manner to obtain an aggregated output result.

By means of weighted summation, the aggregated output result can be made more consistent with the actual situation of each first-level FL server entity, and therefore may be more accurate. In addition, the transmission of the output result and the aggregated output result is safer due to reduced exposure to an internal state of the model, and the amount of data transmitted and communication load are significantly reduced, compared to the traditional manner of transmitting model parameters among parties of federated learning.

For the second-level FL server entity included in the base station, since it functions as the FL server of the first-level FL server entities to collectively perform federated learning, it has a global-model with respect to the local global-models. Since the second-level FL server entity is also a processing entity of the highest layer of the entire federated learning architecture, such a global-model is valid within the coverage area of the base station. The second-level FL server entity may train the global-model according to the above common data and aggregated output result, thereby obtaining parameters of the global-model. Instead of the aggregated output result transmitted to the first-level FL server entities as described above, the parameters of the global-model may be transmitted to the first-level FL server entities to update their local global-models. In other words, when the first-level FL server entity uploads, to the second-level FL server entity, the output result obtained by the local global-model based on the common data, in different embodiments of the present disclosure, the second-level FL server entity may transmit the aggregated output result to the first-level FL server entity, or transmit the parameters of the global-model to the first-level FL server entity, so as to update the local global-model of the first-level FL server entity.

In an embodiment of the present disclosure, the second-level FL server entity may also directly transmit the global-model to the FL participant entities. At this time, the second-level FL server entity may transmit the parameters of the global-model to the FL participant entities, respectively, to directly update the local-models of the FL participant entities. For example, when the local global-model uploaded to the second-level FL server entity can indicate a specific event (e.g., a traffic accident, traffic control, etc.), the second-level FL server entity may transmit the parameters of the global-model to each FL participant entity and each first-level FL server entity immediately after the global-model is obtained by aggregation, so as to help a corresponding terminal device (e.g., a vehicle, etc.) to take an avoidance strategy.

The multi-layer federated learning architecture has been described specifically above, and the interaction among entities in different layers has been described specifically. Due to the introduction of the first-level federated learning server entity and the group, the updating of the local-model can be quickly performed within the group, so that the terminal device can obtain a more accurate model than the local-model obtained based on only the local data in a shorter time, reducing latency compared with the traditional manner that the terminal device directly interacts with the base station. In addition, by interacting the output results obtained based on the common data to help the updating of the model, security is improved and the burden of data transmission is reduced. Moreover, flexible interaction exists among the federated learning participant entity, the first-level federated learning server entity and the second-level federated learning server entity, so that the flexibility and freedom of information sharing are increased, facilitating each terminal device to master more information about the model. Next, a method used in the novel federated learning architecture provided herein will be described.

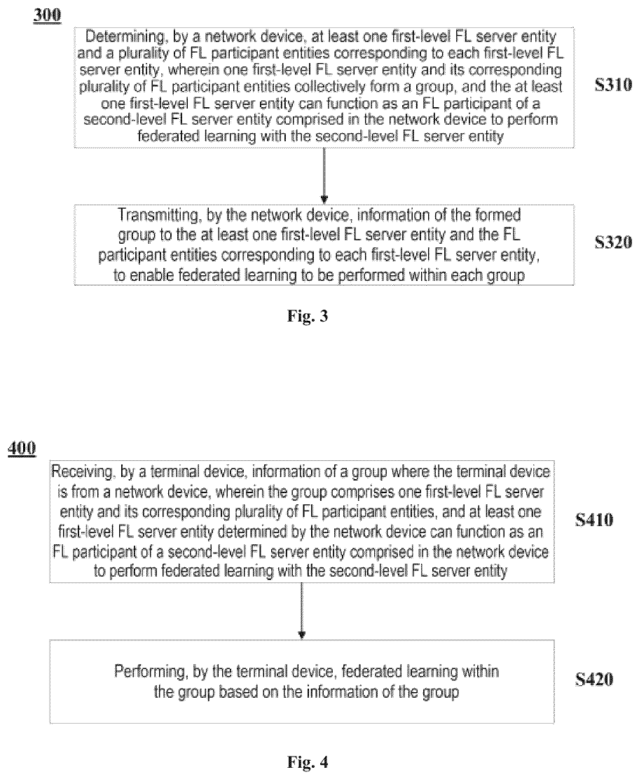

FIG. 3 illustrates a flow diagram of a method executable by a network device in the federated learning architecture provided herein according to an embodiment of the present disclosure. The network device here includes a second-level FL server entity, which may be, for example, a base station, a cloud server, a core network device, and the like.

In S310, the network device determines at least one first-level FL server entity and a plurality of FL participant entities corresponding to each first-level FL server entity, wherein one first-level FL server entity and its corresponding plurality of FL participant entities collectively form a group, and the at least one first-level FL server entity can function as an FL participant of a second-level FL server entity comprised in the network device to perform federated learning with the second-level FL server entity. In S320, the network device transmits information of the formed group to the at least one first-level FL server entity and the FL participant entities corresponding to each first-level FL server entity, to enable federated learning to be performed within each group. For the S310 and S320 and other operations, reference may be made to the above description about FIG. 2, which will not be repeated here.

FIG. 4 illustrates a flow diagram of a method executable by a terminal device in the federated learning architecture provided herein according to an embodiment of the present disclosure. The terminal device here includes a first-level FL server entity and/or an FL participant entity, which may be, for example, a user equipment (UE), or another device with an information processing capability, such as a tablet, a desktop, a computer, and a super computer.

In S410, the terminal device receives, from a network device, information of a group where the terminal device is, wherein the group comprises one first-level FL server entity and its corresponding plurality of FL participant entities, and at least one first-level FL server entity determined by the network device can function as an FL participant of a second-level FL server entity comprised in the network device to perform federated learning with the second-level FL server entity. In S420, the terminal device performs federated learning within the group based on the information of the group. For the S410 and S420 and other operations, reference may be made to the above description about FIG. 2, which will not be repeated here.

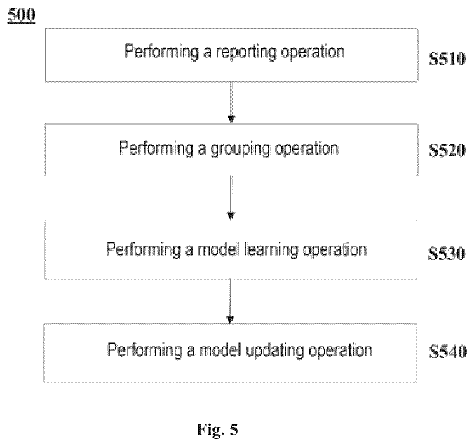

FIG. 5 is a flow diagram of a method used in a federated learning procedure in the federated learning architecture provided herein according to an embodiment of the present disclosure.

In S510, a reporting operation is performed. All terminal devices report, to a cloud server (e.g., located in a base station), their own computing resources, radio channel environments, location information, path planning, etc.

In S520, a grouping operation is performed. The cloud server selects, based on a predetermined criterion, a manager device, which comprises a first-level FL server entity, and informs all terminal devices participating in federated learning within its coverage area of grouping information of federated learning, so that each terminal device knows which group and/or which layer of the architecture it is in.

In S530, a model learning operation is performed. An FL participant entity in a terminal device located in the first layer and a first-level FL server entity (if any) in a terminal device located in the second layer and not having a lower layer may train a local-model and a local global-model (wherein initialization of these models is completed by transmitting a global-model by the cloud server or the like) according to local data, respectively. The FL participant entity in the terminal device located in the first layer reports, to a first-level FL server entity in a terminal device (which may also be referred to as a manager device) located in the second layer in the group it belongs to, a prediction score of an intermediate result learned by the local-model (i.e., the above output result of the local-model that is obtained based on the common data transmitted by the first-level FL server entity), for example, in a manner of D2D. It is noted that when a same terminal device includes both an FL participant entity and a first-level FL server entity, the terminal device may be located in the first and second layers simultaneously. For a terminal device without a lower layer, it reports, to the cloud server, a prediction score of an intermediate result learned by the local global-model (i.e., the above output result of the local-model that is obtained based on the common data transmitted by the second-level FL server entity).

In S540, a model updating operation is performed. The first-level FL server entity in the manager device aggregates the prediction scores from different terminal devices in its responsible group (or corresponding area), and transmits an average of the prediction scores to these terminal devices, so that they update their respective local-models. In addition, the first-level FL server entity also performs federated learning with the second-level FL server entity in the cloud server, to update the local global-model of the first-level FL server entity. Moreover, after obtaining the global-model, the second-level FL server entity can transmit the global-model to different terminal devices in a point-to-point manner according to their requests.

The above S510 to S540 may be performed in each iteration. When a model iteration among manager devices is required, in each iteration, in addition to performing the above S510 to S540, prediction scores of local global-models of their respective responsible groups (or corresponding areas) may be interacted among the manager devices in a manner of D2D.

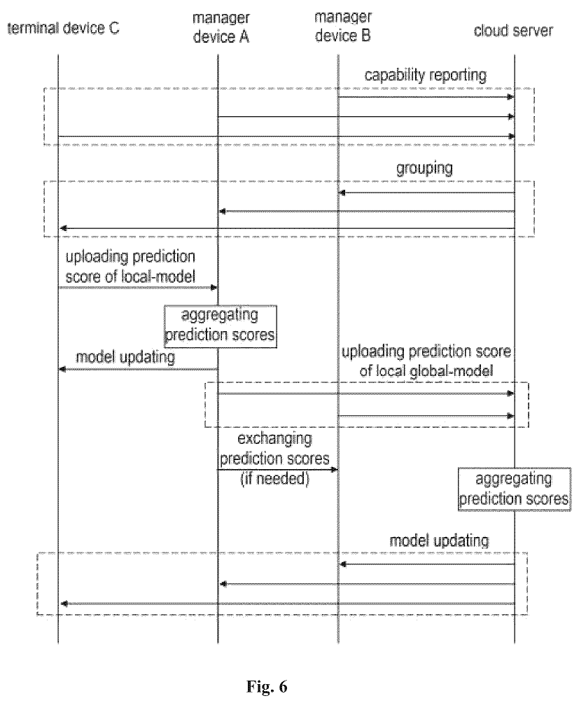

FIG. 6 is a sequence diagram of an example of information exchange in the federated learning architecture provided herein according to an embodiment of the present disclosure.

As shown in FIG. 6, terminal devices report their respective capabilities to a cloud server, and the cloud server groups these terminal devices according to the reported capabilities, thereby determining, as an example, manager devices A and B each including a first-level FL server entity, as well as a terminal device C including an FL participant entity located in a lower layer of the manager device A. Although only two manager devices and one terminal device are shown in FIG. 6, there may be more or fewer manager devices and each manager device has, in its group, one or more terminal device including an FL participant entity.

The terminal device C uploads a prediction score to the manager device A. The manager device A aggregates prediction scores uploaded by all FL participant entities within the group to obtain an aggregated prediction score, and helps the terminal device C to update its local-model by transmitting the aggregated prediction score to it. The manager devices A and B may also transmit prediction scores of local global-models to the cloud server, so that the cloud server may perform aggregation according to prediction scores uploaded by all first-level FL participant entities to obtain an aggregated prediction score. The cloud server may obtain a global-model according to common data previously transmitted to obtain the prediction scores and the aggregated prediction score, and transmit the global-model to the manager devices A and B as well as the terminal device C to update their respective models.

The above federated learning architecture can be utilized in the Internet of Vehicles. For example, one base station may serve a plurality of intersections, wherein different intersections have different traffic flows. According to locations of the intersections, the base station transmits information of vehicles belonging to different areas that is usable for federated learning, while the base station selects a multi-access edge computing device (MEC) close to each intersection as a manager device of the area. Vehicles driving at different intersections transmit model prediction results of local learning results to corresponding MECs, and the MEC merges the model prediction results to update local-models of all the vehicles participating in the federated learning in the area. The vehicle updates the local-model, and then performs iteration of data training according to local data. On the other hand, the MECs upload model prediction results of local global-models to a cloud server, and the cloud server merges the results of the plurality of MECs and can generate a global-model. In response to a demand of a vehicle A at a certain intersection, the global-model is directly transmitted to the vehicle A, because the vehicle A which is preparing to drive to an intersection within another coverage area needs this information as priori model information. When the prediction result of the local global-model of the MEC comprises a traffic accident in the corresponding area, the local global-model of the area is rapidly merged by the cloud server, and then the obtained global-model is transmitted to each vehicle participating in the federated learning in the coverage area, to ensure that any vehicle to the location can adopt a universal avoidance strategy.

The exemplary electronic devices and methods according to the embodiments of the present disclosure have been described above, respectively. It should be understood that the operations or functions of these electronic devices may be combined with one another, thereby achieving more or less operations or functions than those described. The operational steps of the methods may also be combined with one another in any suitable order, thereby similarly achieving more or less operations than those described.

It should be understood that machine-executable instructions in a machine-readable storage medium or program product according to the embodiments of the present disclosure may be configured to perform the operations corresponding to the above device and method embodiments. When referring to the above device and method embodiments, the embodiments of the machine-readable storage medium or program product are apparent to those skilled in the art, and therefore are not repeated. The machine-readable storage medium and program product for carrying or including the above machine-executable instructions also fall within the scope of the present disclosure. Such a storage medium may include, but is not limited to, a floppy disk, optical disk, magneto-optical disk, memory card, memory stick, and the like.

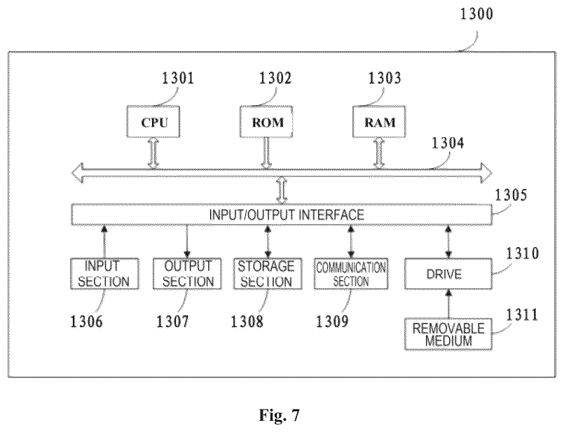

In addition, it should be understood that the above series of processes and devices may also be implemented by software and/or firmware. In the case of implementation by software and/or firmware, a program forming the software is installed from a storage medium or a network to a computer having a dedicated hardware structure, such as a general-purpose personal computer 1300 shown in FIG. 7, and this computer can execute various functions and the like when having various programs installed therein. FIG. 7 is a block diagram illustrating an example structure of a personal computer as an information processing device employable in an embodiment of the present disclosure. In one example, the personal computer may correspond to the above exemplary terminal device according to the present disclosure.

In FIG. 7, a central processing unit (CPU) 1301 executes various processes according to a program stored in a read-only memory (ROM) 1302 or a program loaded from a storage section 1308 to a random access memory (RAM) 1303. In the RAM 1303, data needed when the CPU 1301 executes various processes and the like is also stored as needed.

The CPU 1301, the ROM 1302, and the RAM 1303 are connected to each other via a bus 1304. An input/output interface 1305 is also connected to the bus 1304.

The following components are connected to the input/output interface 1305: an input section 1306 including a keyboard, a mouse, and the like; an output section 1307 including a display such as a cathode ray tube (CRT), a liquid crystal display (LCD), and a speaker, etc.; the storage section 1308 including a hard disk and the like; and a communication section 1309 including a network interface card such as a LAN card, and a modem. The communication section 1309 performs communication processing via a network such as the Internet.

A drive 1310 is also connected to the input/output interface 1305 as needed. A removable medium 1311 such as a magnetic disk, an optical disk, a magneto-optical disk, and a semiconductor memory, is mounted on the drive 1310 as needed, so that a computer program read out therefrom is installed into the storage section 1308 as needed.

In a case where the above series of processes are implemented by software, a program forming the software is installed from a network such as the Internet or a storage medium such as the removable medium 1311.

It should be understood by those skilled in the art that such a storage medium is not limited to the removable medium 1311 shown in FIG. 7, which has therein stored the program and is distributed separately from the device to provide the program to a user. Examples of the removable medium 1311 include a magnetic disk (including a floppy disk (registered trademark)), an optical disk (including a compact disc read-only memory (CD-ROM) and a digital versatile disc (DVD)), a magneto-optical disk (including a mini disk (MD) (registered trademark)), and a semiconductor memory. Alternatively, the storage medium may be the ROM 1302, a hard disk included in the storage section 1308, and the like, which have therein stored programs and are distributed to a user together with the device including them.

The technique of the present disclosure can be applied to a variety of products. For example, the base station mentioned in this disclosure may be implemented as any type of evolved node B (gNB), such as a macro gNB and a small gNB. The small gNB may be a gNB covering a cell smaller than a macro cell, such as a pico gNB, a micro gNB, and a homehold (femto) gNB. Alternatively, the base station may be implemented as any other type of base station, such as a NodeB and a base transceiver station (BTS). The base station may include: a main body (also referred to as a base station device) configured to control radio communication; and one or more remote radio heads (RRHs) arranged at a different location from the main body. In addition, various types of terminals, which will be described below, can each operate as a base station by temporarily or semi-persistently performing a base station function.

For example, the terminal device mentioned in this disclosure, also referred to as a user equipment in some examples, may be implemented as a mobile terminal (such as a smartphone, a tablet personal computer (PC), a notebook PC, a portable game terminal, a portable/dongle-type mobile router, and a digital camera device), or a car-mounted terminal (such as a car navigation device). The user equipment may also be implemented as a terminal performing machine-to-machine (M2M) communication (also referred to as a machine type communication (MTC) terminal). Furthermore, the user equipment may be a radio communication module (such as an integrated circuit module including a single chip) mounted on each of the above terminals.

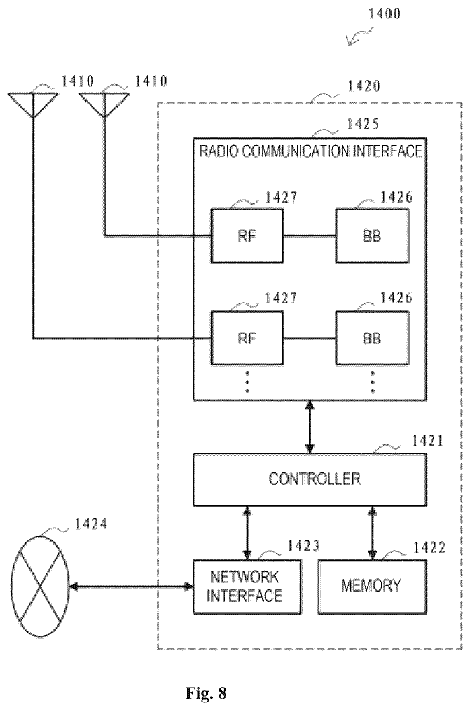

Application examples according to the present disclosure will be described below with reference to FIGS. 8 to 11.

[Application Example with Respect to Base Station]

It should be understood that the term base station in this disclosure has a full breadth of its ordinary meaning and includes at least a radio communication station used as a part of a wireless communication system or radio system to facilitate communication. Examples of the base station may be, for example, but are not limited to the following: the base station may be one or both of a base transceiver station (BTS) and a base station controller (BSC) in a GSM system, may be one or both of a radio network controller (RNC) and a Node B in a WCDMA system, may be an eNB in LTE and LTE-Advanced systems, or may be a corresponding network node in a future communication system (e.g., a gNB, an eLTE eNB, etc., which may occur in a 5G communication system). Part of the functions in the base station of the present disclosure may also be implemented as an entity having a control function for communication in D2D, M2M, and V2V communication scenarios, or as an entity functioning as spectrum coordination in a cognitive radio communication scenario.

### First Application Example

FIG. 8 is a block diagram illustrating a first example of a schematic configuration of a gNB to which the technique of the present disclosure can be applied. The gNB 1400 includes a plurality of antennas 1410 and a base station device 1420. The base station device 1420 and each antenna 1410 may be connected to each other via an RF cable. In one implementation, the gNB 1400 (or the base station device 1420) here may correspond to the above electronic device(s) 300A, 1300A, and/or 1500B.

Each of the antennas 1410 includes a single or plurality of antenna element(s) (such as a plurality of antenna elements included in a multi-input multi-output (MIMO) antenna), and is used for transmitting and receiving radio signals by the base station device 1420. As shown in FIG. 8, the gNB 1400 may include the plurality of antennas 1410. For example, the plurality of antennas 1410 may be compatible with a plurality of frequency bands used by the gNB 1400.

The base station device 1420 includes a controller 1421, a memory 1422, a network interface 1423, and a radio communication interface 1425.

The controller 1421 may be, for example, a CPU or a DSP, and operates various functions of higher layers of the base station device 1420. For example, the controller 1421 generates a data packet according to data in a signal processed by the radio communication interface 1425, and transmits the generated packet via the network interface 1423. The controller 1421 may bundle data from a plurality of baseband processors to generate a bundle packet, and transmit the generated bundle packet. The controller 1421 may have a logic function of performing the following control: such as radio resource control, radio bearer control, mobile management, admission control and scheduling. This control may be performed in conjunction with a nearby gNB or core network node. The memory 1422 includes a RAM and a ROM, and stores a program executed by the controller 1421 and various types of control data (such as a terminal list, transmission power data, and scheduling data).

The network interface 1423 is a communication interface for connecting the base station device 1420 to a core network 1424. The controller 1421 may communicate with a core network node or another gNB via the network interface 1423. In this case, the gNB 1400 and the core network node or other gNB may be connected to each other through a logical interface (such as an SI interface and an X2 interface). The network interface 1423 may also be a wired communication interface, or a radio communication interface for a radio backhaul. If the network interface 1423 is a radio communication interface, the network interface 1423 may use a higher frequency band for radio communication, compared to a frequency band used by the radio communication interface 1425.

The radio communication interface 1425 supports any cellular communication solution (such as long term evolution (LTE) and LTE-advanced), and provides wireless connection to a terminal located in a cell of the gNB 1400 via the antenna 1410. The radio communication interface 1425 may generally include, for example, a baseband (BB) processor 1426 and an RF circuit 1427. The BB processor 1426 may perform, for example, encoding/decoding, modulation/demodulation, and multiplexing/demultiplexing, and perform various types of signal processing for layers (e.g., L1, medium access control (MAC), radio link control (RLC) and packet data convergence protocol (PDCP)). Instead of the controller 1421, the BB processor 1426 may have some or all of the above logic functions. The BB processor 1426 may be a memory for storing a communication control program, or a module including a processor configured to execute a program and related circuits. Updating the program may make the function of the BB processor 1426 to change. The module may be a card or blade inserted into a slot of the base station device 1420. Alternatively, the module may be a chip mounted on a card or blade. Meanwhile, the RF circuit 1427 may include, for example, a mixer, a filter, and an amplifier, and transmit and receive radio signals via the antenna 1410. Although FIG. 8 shows the example that one RF circuit 1427 is connected with one antenna 1410, the present disclosure is not limited to this illustration, and instead, one RF circuit 1427 may be connected with a plurality of antennas 1410 at the same time.

As shown in FIG. 8, the radio communication interface 1425 may include a plurality of BB processors 1426. For example, the plurality of BB processors 1426 may be compatible with the plurality of frequency bands used by the gNB 1400. As shown in FIG. 8, the radio communication interface 1425 may include a plurality of RF circuits 1427. For example, the plurality of RF circuits 1427 may be compatible with the plurality of antenna elements. Although FIG. 8 shows the example where the radio communication interface 1425 includes the plurality of BB processors 1426 and the plurality of RF circuits 1427, the radio communication interface 1425 may further include a single BB processor 1426 or a single RF circuit 1427.

### Second Application Example

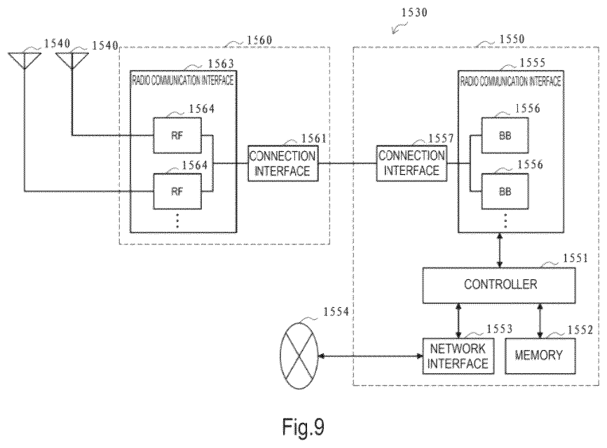

FIG. 9 is a block diagram illustrating a second example of a schematic configuration of a gNB to which the technique of the present disclosure can be applied. The gNB 1530 includes a plurality of antennas 1540, a base station device 1550, and an RRH 1560. The RRH 1560 and each antenna 1540 may be connected to each other via an RF cable. The base station device 1550 and the RRH 1560 may be connected to each other via a high-speed line such as an optical fiber cable. In one implementation, the gNB 1530 (or the base station device 1550) here can correspond to the above electronic device(s) 300A, 1300A, and/or 1500B.

Each of the antennas 1540 includes a single or plurality of antenna element(s) (such as a plurality of antenna elements included in a MIMO antenna) and is used for transmitting and receiving radio signals by the RRH 1560. As shown in FIG. 9, the gNB 1530 may include a plurality of antennas 1540. For example, the plurality of antennas 1540 may be compatible with a plurality of frequency bands used by the gNB 1530.

The base station device 1550 includes a controller 1551, a memory 1552, a network interface 1553, a radio communication interface 1555, and a connection interface 1557. The controller 1551, memory 1552 and network interface 1553 are the same as the controller 1421, memory 1422 and network interface 1423 described with reference to FIG. 8.

The radio communication interface 1555 supports any cellular communication solution (such as LTE and LTE-advanced) and provides radio communication to a terminal located in a sector corresponding to the RRH 1560 via the RRH 1560 and the antenna 1540. The radio communication interface 1555 may generally include, for example, a BB processor 1556. The BB processor 1556 is the same as the BB processor 1426 described with reference to FIG. 8, except that the BB processor 1556 is connected to an RF circuit 1564 of the RRH 1560 via the connection interface 1557. As shown in FIG. 9, the radio communication interface 1555 may include a plurality of BB processors 1556. For example, the plurality of BB processors 1556 may be compatible with a plurality of frequency bands used by the gNB 1530. Although FIG. 9 shows the example in which the radio communication interface 1555 includes the plurality of BB processors 1556, the radio communication interface 1555 can also include a single BB processor 1556.

The connection interface 1557 is an interface for connecting the base station device 1550 (radio communication interface 1555) to the RRH 1560. The connection interface 1557 may also be a communication module for communication in the above high-speed line connecting the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 may also be a communication module used for communication in the above high-speed line.

The radio communication interface 1563 transmits and receives radio signals via the antenna 1540. The radio communication interface 1563 may generally include, for example, the RF circuit 1564. The RF circuit 1564 may include, for example, a mixer, a filter, and an amplifier, and transmits and receives radio signals via the antenna 1540. Although FIG. 9 shows the example that one RF circuit 1564 is connected with one antenna 1540, the present disclosure is not limited to this illustration, and instead, one RF circuit 1564 may connect a plurality of antennas 1540 at the same time.

As shown in FIG. 9, the radio communication interface 1563 may include a plurality of RF circuits 1564. For example, the plurality of RF circuits 1564 may support a plurality of antenna elements. Although FIG. 9 shows the example in which the radio communication interface 1563 includes the plurality of RF circuits 1564, the radio communication interface 1563 may also include a single RF circuit 1564.

### Application Example with Respect to User Equipment

### First Application Example

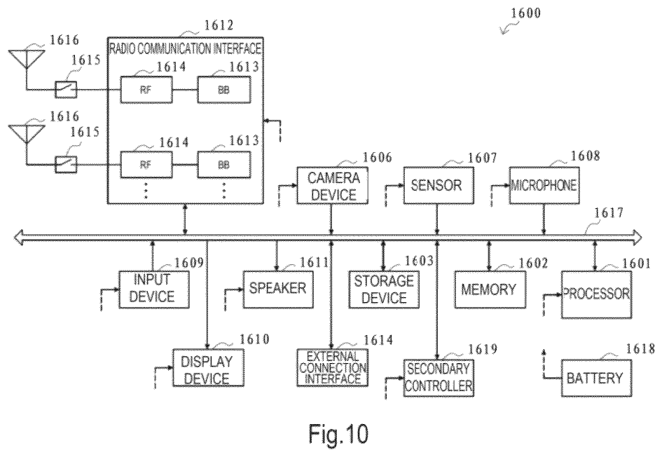

FIG. 10 is a block diagram illustrating an example of a schematic configuration of a smartphone 1600 to which the technique of the present disclosure can be applied. The smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and a secondary controller 1619. In one implementation, the smartphone 1600 (or the processor 1601) here may correspond to the above terminal device(s) 300B and/or 1500A.

The processor 1601 may be, for example, a CPU or a system on a chip (SoC), and controls functions of an application layer and other layers of the smartphone 1600. The memory 1602 includes a RAM and a ROM, and stores data and a program executed by the processor 1601. The storage device 1603 may include a storage medium such as a semiconductor memory and a hard disk. The external connection interface 1604 is an interface for connecting an external device (such as a memory card and a universal serial bus (USB) device) to the smartphone 1600.

The camera device 1606 includes an image sensor (such as a charge coupled device (CCD) and a complementary metal oxide semiconductor (CMOS)), and generates a capture image. The sensor 1607 may include a set of sensors, such as measurement sensors, gyro sensors, geomagnetic and acceleration sensors. The microphone 1608 converts sound input to the smartphone 1600 into an audio signal. The input device 1609 includes, for example, a touch sensor configured to detect a touch on a screen of the display device 1610, a keypad, a keyboard, a button, or a switch, and receives an operation or information input from a user. The display device 1610 includes a screen (such as a liquid crystal display (LCD) and an organic light emitting diode (OLED) display), and displays an output image of the smartphone 1600. The speaker 1611 converts an audio signal output from the smartphone 1600 into sound.

The radio communication interface 1612 supports any cellular communication solution (such as LTE and LTE-advanced) and performs radio communication. The radio communication interface 1612 may generally include, for example, a BB processor 1613 and an RF circuit 1614. The BB processor may 1613 perform, for example, encoding/decoding, modulation/demodulation, and multiplexing/demultiplexing, and perform various types of signal processing for radio communication. Meanwhile, the RF circuit 1614 may include, for example, a mixer, a filter, and an amplifier, and transmit and receive a radio signal via the antenna 1616. The radio communication interface 1612 may be one chip module having the BB processor 1613 and the RF circuit 1614 integrated thereon. As shown in FIG. 10, the radio communication interface 1612 may include a plurality of BB processors 1613 and a plurality of RF circuits 1614. Although FIG. 10 shows the example in which the radio communication interface 1612 includes the plurality of BB processors 1613 and the plurality of RF circuits 1614, the radio communication interface 1612 may also include a single BB processor 1613 or a single RF circuit 1614.

Furthermore, the radio communication interface 1612 may support another type of radio communication solution, such as a short-range radio communication solution, a near field communication solution, and a wireless local area network (LAN) solution, in addition to the cellular communication solution. In this case, the radio communication interface 1612 may include the BB processor 1613 and the RF circuitry 1614 for each radio communication solution.

Each of the antenna switches 1615 switches a connection destination of the antenna 1616 between a plurality of circuits (for example, circuits for different radio communication solutions) included in the radio communication interface 1612.

Each of the antennas 1616 includes a single or plurality of antenna element(s) (such as a plurality of antenna elements included in a MIMO antenna) and is used for transmitting and receiving radio signals by the radio communication interface 1612. As shown in FIG. 10, the smartphone 1600 may include the plurality of antennas 1616. Although FIG. 10 shows the example in which the smartphone 1600 includes the plurality of antennas 1616, the smartphone 1600 may also include a single antenna 1616.

Furthermore, the smartphone 1600 may include an antenna 1616 for each radio communication solution. In this case, the antenna switch 1615 may be omitted from the configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the secondary controller 1619 to each other. The battery 1618 provides power to the various blocks of the smartphone 1600 shown in FIG. 10 via a feeder, which is partially shown as a dashed line in the figure. The secondary controller 1619 operates minimum necessary functions of the smartphone 1600, for example, in a sleep mode.

### Second Application Example

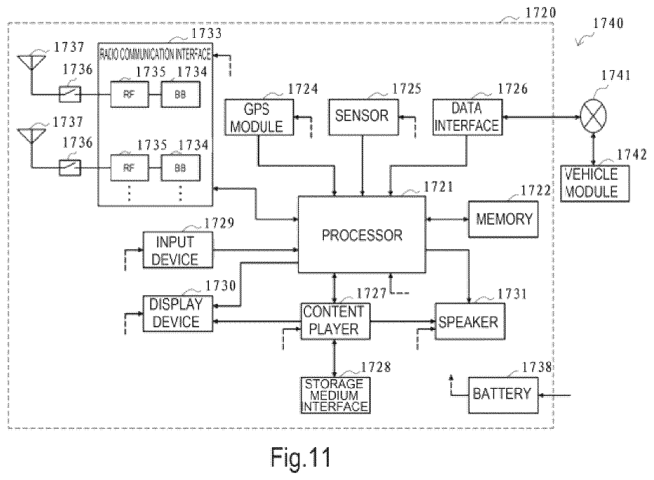

FIG. 11 is a block diagram showing an example of a schematic configuration of a car navigation device 1720 to which the technique of the present disclosure can be applied. The car navigation device 1720 includes a processor 1721, a memory 1722, a global positioning system (GPS) module 1724, a sensor 1725, a data interface 1726, a content player 1727, a storage medium interface 1728, an input device 1729, a display device 1730, a speaker 1731, a radio communication interface 1733, one or more antenna switches 1736, one or more antennas 1737, and a battery 1738. In one implementation, the car navigation device 1720 (or the processor 1721) here may correspond to the above terminal device(s) 300B and/or 1500A.

The processor 1721 may be, for example, a CPU or a SoC, and controls a navigation function and other functions of the car navigation device 1720. The memory 1722 includes a RAM and a ROM, and stores data and a program executed by the processor 1721.

The GPS module 1724 measures a location (such as latitude, longitude, and altitude) of the car navigation device 1720 using a GPS signal received from a GPS satellite. The sensors 1725 may include a set of sensors such as gyroscope sensors, geomagnetic sensors, and air pressure sensors. The data interface 1726 is, via a terminal not shown, connected to, for example, a car-mounted network 1741, and acquires data (such as vehicle velocity data) generated by a vehicle.

The content player 1727 reproduces content stored in a storage medium (such as a CD and a DVD) which is inserted into the storage medium interface 1728. The input device 1729 includes, for example, a touch sensor configured to detect a touch on a screen of the display device 1730, a button, or a switch, and receives an operation or information input from a user. The display device 1730 includes a screen such as an LCD or OLED display, and displays an image of a navigation function or reproduced content. The speaker 1731 outputs sound of a navigation function or reproduced content.

The radio communication interface 1733 supports any cellular communication solution (such as LTE and LTE-advanced) and performs radio communication. The radio communication interface 1733 may generally include, for example, a BB processor 1734 and an RF circuit 1735. The BB processor 1734 may perform, for example, encoding/decoding, modulation/demodulation, and multiplexing/demultiplexing, and perform various types of signal processing for radio communication. Meanwhile, the RF circuit 1735 may include, for example, a mixer, a filter, and an amplifier, and transmit and receive radio signals via the antenna 1737. The radio communication interface 1733 may also be one chip module having the BB processor 1734 and the RF circuit 1735 integrated thereon. As shown in FIG. 11, the radio communication interface 1733 may include a plurality of BB processors 1734 and a plurality of RF circuits 1735. Although FIG. 11 shows the example in which the radio communication interface 1733 includes the plurality of BB processors 1734 and the plurality of RF circuits 1735, the radio communication interface 1733 may also include a single BB processor 1734 or a single RF circuit 1735.

Furthermore, the radio communication interface 1733 may support another type of radio communication solution, such as a short-range radio communication solution, a near field communication solution, and a wireless LAN solution, in addition to the cellular communication solution. In this case, for each radio communication solution, the radio communication interface 1733 may include the BB processor 1734 and the RF circuit 1735.

Each of the antenna switches 1736 switches a connection destination of the antenna 1737 between a plurality of circuits (such as circuits for different radio communication solutions) included in the radio communication interface 1733.

Each of the antennas 1737 includes a single or plurality of antenna element(s) (such as a plurality of antenna elements included in a MIMO antenna) and is used for transmitting and receiving radio signals by the radio communication interface 1733. As shown in FIG. 11, the car navigation device 1720 may include the plurality of antennas 1737. Although FIG. 11 shows the example in which the car navigation device 1720 includes the plurality of antennas 1737, the car navigation device 1720 may also include a single antenna 1737.

Furthermore, the car navigation device 1720 may include an antenna 1737 for each radio communication solution. In this case, the antenna switch 1736 may be omitted from the configuration of the car navigation device 1720.

A battery 1738 provides power to the various blocks of the car navigation device 1720 shown in FIG. 11 via a feeder, which is partially shown as a dashed line in the figure. The battery 1738 accumulates power supplied from the vehicle.

The technique of this disclosure may also be implemented as a car-mounted system (or vehicle) 1740 including the car navigation device 1720, a car-mounted network 1741, and one or more blocks in a vehicle module 1742. The vehicle module 1742 generates vehicle data (such as vehicle velocity, engine velocity, and fault information) and outputs the generated data to the car-mounted network 1741.

The exemplary embodiments of the present disclosure have been described above with reference to the drawings, but the present disclosure is of course not limited to the above examples. Those skilled in the art may obtain various changes and modifications within the scope of the attached claims, and should understand that these changes and modifications will naturally fall within the technical scope of the present disclosure.

For example, a plurality of functions included in one unit in the above embodiments may be implemented by separate devices. Alternatively, a plurality of functions implemented by a plurality of units in the above embodiments may be implemented by separate devices, respectively. In addition, one of the above functions may be implemented by a plurality of units. Needless to say, such a configuration is included within the technical scope of the present disclosure.

In this description, the steps described in the flow diagrams include not only the processing performed in the temporal sequence in the described order but also the processing performed in parallel or individually rather than necessarily in the temporal sequence. Furthermore, even in the steps of the processing in the temporal sequence, needless to say, the order can be appropriately changed.

Although the present disclosure and its advantages have been described in detail, it should be understood that various changes, substitutions and alterations can be made without departing from the spirit and scope of the present disclosure that are defined by the attached claims. Moreover, the terms “comprise”, “include”, or any other variation thereof in the embodiments of the present disclosure are intended to cover a non-exclusive inclusion, such that a process, method, article, or device that comprises a list of elements not only includes those elements, but also includes other elements not expressly listed, or elements inherent to such a process, method, article, or device. Without more limitations, an element defined by a statement “comprising a . . . ” does not exclude the presence of another identical element in a process, method, article, or device that includes the element.

As will be appreciated from the description herein, the embodiments of the present disclosure may be configured as follows:

1. An electronic device used on a network device side in a radio communication system, comprising a processing circuitry configured to:
determine at least one first-level federated learning (FL) server entity and a plurality of FL participant entities corresponding to each first-level FL server entity, wherein one first-level FL server entity and its corresponding plurality of FL participant entities collectively form a group, and the at least one first-level FL server entity can function as an FL participant of a second-level FL server entity comprised in the electronic device to perform federated learning with the second-level FL server entity; and transmit information of the formed group to the at least one first-level FL server entity and the FL participant entities corresponding to each first-level FL server entity, to enable federated learning to be performed within each group.

2. The electronic device according to clause 1, wherein the processing circuitry is further configured to:
receive, from terminal devices within a coverage area of the electronic device, one or more of processing capability, machine learning capability, geographic location, radio channel quality and movement trajectory information of the terminal devices;
according to the received one or more of the processing capacity, the geographic location, the radio channel quality and the movement trajectory information of the terminal devices, select at least one manager device among the terminal devices, wherein each manager device comprises a first-level FL server entity; and
for each manager device, determine terminal devices within a predetermined distance from the manager device as comprising FL participant entities corresponding to the first-level FL server entity comprised in the manager device.

3. The electronic device according to clause 2, wherein at least one manager device further comprises an FL participant entity, and the first-level FL server entity and the FL participant entity comprised in the manager device are in a same group.

4. The electronic device according to clause 2, wherein terminal devices outside the predetermined distance from each manager device are determined as comprising FL entities which function as FL participants to perform federated learning with the second-level server entity together with the first-level FL server entity.

5. The electronic device according to clause 1, wherein in a procedure of performing federated learning within a group, the FL participant entities of the group upload local-model related information to the first-level FL server entity of the group using direct communication through links between terminal devices and the electronic device, so that the first-level FL server entity updates local-models of the FL participant entities of the group by aggregating the received local-model related information.

6. The electronic device according to clause 5, wherein the local-model related information is an output result calculated by the FL participant entity according to common data transmitted by the first-level FL server entity based on the local-model.

7. The electronic device according to clause 1, wherein in a procedure of performing federated learning by the at least one first-level FL server entity and the second-level FL server entity, the processing circuitry is further configured to:
receive, from each first-level FL server entity of the at least one first-level FL server entity, local global-model related information of the first-level FL server entity, wherein a local global-model of the first-level FL server entity is an aggregation result of local-models of FL participant entities of the group where the first-level FL server entity is; and
update the local global-model of the first-level FL server entity by aggregating the received local global-model related information.

8. The electronic device according to clause 7, wherein the local global-model related information is an output result calculated by the first-level FL server entity according to common data transmitted by the second-level FL server entity based on the local global-model.

9. The electronic device according to clause 8, wherein the processing circuitry is further configured to:
receive, from each first-level FL server entity, two or more of a first quantity related to local global-model prediction accuracy, a second quantity related to channel quality, and a third quantity related to historical and/or future trajectory, of the terminal device where the first-level FL server entity is; and
determine a weight corresponding to the first-level FL server entity based on the two or more of the first quantity, the second quantity and the third quantity,
wherein the local global-model of the first-level FL server entity is updated by weighted aggregation of the output result received from the first-level FL server entity using the weight corresponding to the first-level FL server entity.

10. The electronic device according to clause 9, wherein the weight is calculated as a linear sum of at least two of the first quantity, the second quantity and the third quantity.

11. The electronic device according to clause 7, wherein the processing circuitry is further configured to:
obtain a global-model of the second-level FL server entity by aggregating the received local global-model related information; and
transmit the global-model to the plurality of FL participant entities corresponding to each first-level FL server entity.

12. The electronic device according to clause 1, wherein the information of the formed group comprises one or more of: an identifier ID of a terminal device where the first-level FL server entity in the group is and a group ID of the group.

13. The electronic device according to clause 12, wherein the information of the formed group further comprises: a group ID of a group in an adjacent geographic location.

14. An electronic device used on a user equipment side in a radio communication system, comprising a processing circuitry configured to:
receive, from an electronic device on a network device side, information of a group where the electronic device on the user equipment side is, wherein the group comprises one first-level FL server entity and its corresponding plurality of FL participant entities, and at least one first-level FL server entity determined by the electronic device on the network device side can function as an FL participant of a second-level FL server entity comprised in the electronic device on the network device side to perform federated learning with the second-level FL server entity; and
perform federated learning within the group based on the information of the group.

15. The electronic device according to clause 14, wherein in a case where the electronic device comprises a first-level FL server entity, the processing circuitry is configured to:
receive, from FL participant entities of the group where the electronic device is, local-model related information; and
update local-models of the FL participant entities of the group by aggregating the received local-model related information.

16. The electronic device according to clause 15, wherein the local-model related information is an output result calculated by the FL participant entity according to common data transmitted by the first-level FL server entity based on the local-model.

17. The electronic device according to clause 16, wherein the processing circuitry is further configured to:
receive, from each FL participant entity in the group where the electronic device is, two or more of a first quantity related to local-model prediction accuracy, a second quantity related to channel quality, and a third quantity related to historical and/or future trajectory, of the terminal device where the FL participant entity is; and
determine a weight corresponding to the FL participant entity based on the two or more of the first quantity, the second quantity, and the third quantity,
wherein the local-model of the FL participant entity of the group is updated by weighted aggregation of the output result received from the FL participant entity using the weight corresponding to the FL participant entity.

18. The electronic device according to clause 16, wherein the processing circuitry is further configured to:
receive, from the electronic device on the network device side, a weight corresponding to each FL participant entity of the group, the weight being determined by the electronic device on the network device side according to any two or more of a first quantity related to local-model prediction accuracy, a second quantity related to channel quality, and a third quantity related to historical and/or future trajectory, of the terminal device where the FL participant entity is, that are received from each FL participant entity of the group,
wherein the local-model of the FL participant entity of the group is updated by weighted aggregation of the output result received from the FL participant entity using the weight corresponding to the FL participant entity.

19. The electronic device according to clause 17 or 18, wherein the weight is calculated as a linear sum of at least two of the first quantity, the second quantity and the third quantity.

20. The electronic device according to clause 15, wherein the processing circuitry is further configured to:
obtain a local global-model by aggregating the received local-model related information, wherein the local global-model of the first-level FL server entity is an aggregation result of the local-models of the FL participant entities of the group where the first-level FL server entity is; and
according to a request from an FL participant entity of another group, transmit the local global-model to the FL participant entity.

21. The electronic device according to clause 14, wherein in a case where the electronic device comprises the first-level FL server entity, the processing circuitry is configured to:
transmit local global-model related information to the second-level FL server entity, so that the second-level FL server entity updates a local global-model of the first-level FL server entity by aggregating the received local global-model related information, wherein the local global-model of the first-level FL server entity is an aggregation result of local-models of the FL participant entities of the group where the first-level FL server entity is.

22. The electronic device according to clause 21, wherein the local global-model related information is an output result calculated by the first-level FL server entity according to common data transmitted by the second-level FL server entity based on the local global-model.

23. The electronic device according to clause 22, wherein the processing circuitry is further configured to:
exchange the local global-model related information with another first-level FL server entity.

24. The electronic device according to clause 14, wherein in a case where the electronic device comprises an FL participant entity, the processing circuitry is further configured to:
transmit local-model related information to the first-level FL server entity of the group where the electronic device is, so that the first-level FL server updates local-models of FL participant entities of the group by aggregating the local-model related information received from the FL participant entities of the group.

25. The electronic device according to clause 24, wherein the processing circuitry is further configured to:
receive common data from the first-level FL server entity;
calculate an output result based on the local-model according to the common data; and
transmit the output result to another FL participant entity within the same group.

26. The electronic device according to clause 25, wherein the processing circuitry is further configured to:
transmit a request message to the other FL participant entity through synchronization channel information (SCI); and
transmit the output result to the other FL participant entity by carrying information for demodulating and decoding a physical side link control channel (PSSCH) by the SCI and by carrying the output result by the PSSCH.

27. The electronic device according to clause 25, wherein the processing circuitry is further configured to:
transmit the output result to an FL participant entity within a different group through a PC5 link.

28. The electronic device according to clause 25, wherein the processing circuitry is further configured to:
transmit the output result to the first-level FL server entity in the same group and/or a different group in a manner of D2D.

29. The electronic device according to clause 14, wherein the information of the group comprises one or more of: an identifier ID of a terminal device where the first-level FL server entity in the group is and a group ID of the group.

30. The electronic device according to clause 29, wherein the information of the group further comprises: a group ID of a group in an adjacent geographic location.

31. A method used in a radio communication system, comprising:
determining at least one first-level federated learning (FL) server entity and a plurality of FL participant entities corresponding to each first-level FL server entity, wherein one first-level FL server entity and its corresponding plurality of FL participant entities collectively form a group, and the at least one first-level FL server entity can function as an FL participant of a second-level FL server entity comprised in a network device to perform federated learning with the second-level FL server entity; and
transmitting information of the formed group to the at least one first-level FL server entity and the FL participant entities corresponding to each first-level FL server entity, to enable federated learning to be performed within each group.

32. A method used in a radio communication system, comprising:
receiving, from a network device, information of a group where a terminal device is, wherein the group comprises one first-level FL server entity and its corresponding plurality of FL participant entities, and at least one first-level FL server entity determined by the network device can function as an FL participant of a second-level FL server entity comprised in the network device to perform federated learning with the second-level FL server entity; and
performing federated learning within the group based on the information of the group.

33. A computer-readable storage medium storing one or more instructions which, when executed by one or more processors of an electronic device, cause the electronic device to perform the method according to clause 31 or 32.

1. An electronic device used on a network device side in a radio communication system, comprising a processing circuitry configured to:
determine at least one first-level federated learning (FL) server entity and a plurality of FL participant entities corresponding to each first-level FL server entity, wherein one first-level FL server entity and its corresponding plurality of FL participant entities collectively form a group, and the at least one first-level FL server entity can function as an FL participant of a second-level FL server entity comprised in the electronic device to perform federated learning with the second-level FL server entity; and
transmit information of the formed group to the at least one first-level FL server entity and the FL participant entities corresponding to each first-level FL server entity, to enable federated learning to be performed within each group.

2. The electronic device according to claim 1, wherein the processing circuitry is further configured to:
receive, from terminal devices within a coverage area of the electronic device, one or more of processing capability, machine learning capability, geographic location, radio channel quality and movement trajectory information of the terminal devices;
according to the received one or more of the processing capacity, the machine learning capability, the geographic location, the radio channel quality and the movement trajectory information of the terminal devices, select at least one manager device among the terminal devices, wherein each manager device comprises a first-level FL server entity; and
for each manager device, determine terminal devices within a predetermined distance from the manager device as comprising FL participant entities corresponding to the first-level FL server entity comprised in the manager device.

3. The electronic device according to claim 2, wherein at least one manager device further comprises an FL participant entity, and the first-level FL server entity and the FL participant entity comprised in the manager device are in a same group; or
wherein terminal devices outside the predetermined distance from each manager device are determined as comprising FL entities which function as FL participants to perform federated learning with the second-level FL server entity together with the first-level FL server entity.

4. (canceled)

5. The electronic device according to claim 1, wherein in a procedure of performing federated learning within a group, the FL participant entities of the group upload local-model related information to the first-level FL server entity of the group using direct communication through links between terminal devices and the electronic device, so that the first-level FL server entity updates local-models of the FL participant entities of the group by aggregating the received local-model related information, and
wherein the local-model related information is an output result calculated by the FL participant entity according to common data transmitted by the first-level FL server entity based on the local-model.

6. (canceled)

7. The electronic device according to claim 1, wherein in a procedure of performing federated learning by the at least one first-level FL server entity and the second-level FL server entity, the processing circuitry is further configured to:
receive, from each first-level FL server entity of the at least one first-level FL server entity, local global-model related information of the first-level FL server entity, wherein a local global-model of the first-level FL server entity is an aggregation result of local-models of FL participant entities of the group where the first-level FL server entity is; and
update the local global-model of the first-level FL server entity by aggregating the received local global-model related information,
wherein the local global-model related information is an output result calculated by the first-level FL server entity according to common data transmitted by the second-level FL server entity based on the local global-model.

8. (canceled)

9. The electronic device according to claim 7, wherein the processing circuitry is further configured to:
receive, from each first-level FL server entity, two or more of a first quantity related to local global-model prediction accuracy, a second quantity related to channel quality, and a third quantity related to historical and/or future trajectory, of the terminal device where the first-level FL server entity is; and
determine a weight corresponding to the first-level FL server entity based on the two or more of the first quantity, the second quantity and the third quantity,
wherein the local global-model of the first-level FL server entity is updated by weighted aggregation of the output result received from the first-level FL server entity using the weight corresponding to the first-level FL server entity.

10. The electronic device according to claim 9, wherein the weight is calculated as a linear sum of at least two of the first quantity, the second quantity and the third quantity.

11. The electronic device according to claim 7, wherein the processing circuitry is further configured to:
obtain a global-model of the second-level FL server entity by aggregating the received local global-model related information; and
transmit the global-model to the plurality of FL participant entities corresponding to each first-level FL server entity.

12. The electronic device according to claim 1, wherein the information of the formed group comprises one or more of: an identifier ID of a terminal device where the first-level FL server entity in the group is and a group ID of the group; or
wherein the information of the formed group comprises one or more of: an identifier ID of a terminal device where the first-level FL server entity in the group is and a group ID of the group, and the information of the formed group further comprises: a group ID of a group in an adjacent geographic location.

13. (canceled)

14. An electronic device used on a user equipment side in a radio communication system, comprising a processing circuitry configured to:
receive, from an electronic device on a network device side, information of a group where the electronic device on the user equipment side is, wherein the group comprises one first-level FL server entity and its corresponding plurality of FL participant entities, and at least one first-level FL server entity determined by the electronic device on the network device side can function as an FL participant of a second-level FL server entity comprised in the electronic device on the network device side to perform federated learning with the second-level FL server entity; and
perform federated learning within the group based on the information of the group.

15. The electronic device according to claim 14, wherein in a case where the electronic device comprises a first-level FL server entity, the processing circuitry is configured to:
receive, from FL participant entities of the group where the electronic device is, local-model related information; and
update local-models of the FL participant entities of the group by aggregating the received local-model related information,
wherein the local-model related information is an output result calculated by the FL participant entity according to common data transmitted by the first-level FL server entity based on the local-model.

16. (canceled)

17. The electronic device according to claim 15, wherein the processing circuitry is further configured to:
receive, from each FL participant entity in the group where the electronic device is, two or more of a first quantity related to local-model prediction accuracy, a second quantity related to channel quality, and a third quantity related to historical and/or future trajectory, of the terminal device where the FL participant entity is, and
determine a weight corresponding to the FL participant entity based on the two or more of the first quantity, the second quantity, and the third quantity,
wherein the local-model of the FL participant entity of the group is updated by weighted aggregation of the output result received from the FL participant entity using the weight corresponding to the FL participant entity;
or
receive, from the electronic device on the network device side, a weight corresponding to each FL participant entity of the group, the weight being determined by the electronic device on the network device side according to any two or more of a first quantity related to local-model prediction accuracy, a second quantity related to channel quality, and a third quantity related to historical and/or future trajectory, of the terminal device where the FL participant entity is, that are received from each FL participant entity of the group,
wherein the local-model of the FL participant entity of the group is updated by weighted aggregation of the output result received from the FL participant entity using the weight corresponding to the FL participant entity.

18. (canceled)

19. The electronic device according to claim 17, wherein the weight is calculated as a linear sum of at least two of the first quantity, the second quantity and the third quantity.

20. The electronic device according to claim 15, wherein the processing circuitry is further configured to:
obtain a local global-model by aggregating the received local-model related information, wherein the local global-model of the first-level FL server entity is an aggregation result of the local-models of the FL participant entities of the group where the first-level FL server entity is; and
according to a request from an FL participant entity of another group, transmit the local global-model to the FL participant entity.

21. The electronic device according to claim 14, wherein in a case where the electronic device comprises the first-level FL server entity, the processing circuitry is configured to:
transmit local global-model related information to the second-level FL server entity, so that the second-level FL server entity updates a local global-model of the first-level FL server entity by aggregating the received local global-model related information, wherein the local global-model of the first-level FL server entity is an aggregation result of local-models of the FL participant entities of the group where the first-level FL server entity is,
wherein the local global-model related information is an output result calculated by the first-level FL server entity according to common data transmitted by the second-level FL server entity based on the local global-model.

22. (canceled)

23. The electronic device according to claim 21, wherein the processing circuitry is further configured to:
exchange the local global-model related information with another first-level FL server entity.

24. The electronic device according to claim 14, wherein in a case where the electronic device comprises an FL participant entity, the processing circuitry is further configured to:
transmit local-model related information to the first-level FL server entity of the group where the electronic device is, so that the first-level FL server entity updates local-models of FL participant entities of the group by aggregating the local-model related information received from the FL participant entities of the group.

25. The electronic device according to claim 24, wherein the processing circuitry is further configured to:
receive common data from the first-level FL server entity;
calculate an output result based on the local-model according to the common data; and
transmit the output result to another FL participant entity within the same group.

26. The electronic device according to claim 25, wherein the processing circuitry is further configured to:
transmit a request message to the other FL participant entity through synchronization channel information (SCI), and
transmit the output result to the other FL participant entity by carrying information for demodulating and decoding a physical side link control channel (PSSCH) by the SCI and by carrying the output result by the PSSCH;
or
transmit the output result to an FL participant entity within a different group through a PC5 link;
or
transmit the output result to the first-level FL server entity in the same group and/or a different group in a manner of D2D.

27.-32. (canceled)

33. A computer-readable storage medium storing one or more instructions which, when executed by one or more processors of an electronic device, cause the electronic device to perform operations, the operations including;
determining at least one first-level federated learning (FL) server entity and a plurality of FL participant entities corresponding to each first-level FL server entity, wherein one first-level FL server entity and its corresponding plurality of FL participant entities collectively form a group, and the at least one first-level FL server entity can function as an FL participant of a second-level FL server entity comprised in a network device to perform federated learning with the second-level FL server entity, and
transmitting information of the formed group to the at least one first-level FL server entity and the FL participant entities corresponding to each first-level FL server entity, to enable federated learning to be performed within each group;
or
receiving, from a network device, information of a group where a terminal device is, wherein the group comprises one first-level FL server entity and its corresponding plurality of FL participant entities, and at least one first-level FL server entity determined by the network device can function as an FL participant of a second-level FL server entity comprised in the network device to perform federated learning with the second-level FL server entity, and
performing federated learning within the group based on the information of the group.
